(19) United States
(12) Patent Application Publication
(10) Pub. No.: US 2007/0161308 A1
(43) Pub. Date: Jul. 12, 2007

(54) Atmospheric pressure plasma-aided antimicrobial finishes of textiles

(75) Inventors: Mohamed Abdelhay Bourham, Raleigh, NC (US); Marian Gayle McCord, Apex, NC (US); Suzanne Rodden Matthews, Raleigh, NC (US); Carrie Elizabeth Cornelius, Raleigh, NC (US)

Correspondence Address: JENKINS, WILSON, TAYLOR & HUNT, P. A., SUITE 1200, UNIVERSITY TOWER, 3100 TOWER BOULEVARD, DURHAM, NC, 27707, US

(73) Assignee: North Carolina State University, Raleigh, NC (US)

(21) Appl. No.: 11/331,438

(22) Filed: Jan. 12, 2006

(51) Int. Cl. B32B 27/04; B05D 1/40

(52) U.S. Cl. 442/123; 427/331

(57) ABSTRACT

Novel methods of producing a textile fabric exhibiting antimicrobial characteristics are provided. The methods include providing a textile fabric having a fabric surface and providing an antimicrobial agent for inclusion on the fabric surface. The methods further include exposing the textile fabric to atmospheric pressure plasma wherein the fabric surface is activated and grafting the antimicrobial agent onto the fabric surface during activation of the fabric surface wherein the antimicrobial agent is copolymerized to form a permanent inclusion on the fabric surface. Novel fabrics exhibiting antimicrobial characteristics are also provided.

### TECHNICAL FIELD

The presently disclosed subject matter relates to textile finishing. More particularly, the presently disclosed subject matter relates to the production of textile fabrics exhibiting antimicrobial characteristics.

### BACKGROUND

A great deal of attention has been paid in recent years to the hazards of bacterial contamination from potential everyday exposure. As such, manufacturers have begun incorporating antimicrobial agents within various household products and articles. One such example is the production of antimicrobial or biocidal fabrics that are synthesized to kill or inhibit the growth of microorganisms such as bacteria, molds, fungi or insects. There is an increased demand for biocidal textiles for hygienic and home usage, as well as an increased demand to protect the healthcare workers and armed personnel deployed in areas susceptible to disease-carrying insects.

Biocidal textiles are composed of natural, synthetic or blends of fibers manufactured from nonwoven or woven fabrics and are available in international markets under various brand names. These fabrics are typically based on some specific biocidal agents added during the melt spinning of the synthetic fibers or during the finishing process of the fabric. While adding biocidal agents to the fibers during melt spinning appears as a viable technique, the added agents tend to have a low wash fastness to repeated washing.

Research in plasma treatment of textile materials and surface modifications has been conducted as a technique to process biocidal textiles. Material surfaces immersed in atmospheric pressure plasmas may be subject to various forms of interactions including, but not limited to, electron and ion impact, radicals-surface interactions, ultraviolet and photon transport, etching, implantation, deposition and redeposition. For textile materials, these interactions may result in surface etching, chain scission, polymerization, cross-linking, development of functional groups, surface roughness, etc.

Surface etching by reactive species may induce breaks in the molecular chains and the derivative particles are released and mixed with the plasma. When active species reach the surface of the substrate, new functional groups could be generated by molecular chain scissions, atoms substitution and recombination. Free radicals can also promote polymerization and cross-linking. Photons from UV radiation may also induce cross-linking between molecules on the substrate surface. The formation of functional groups depends on the plasma state, plasma parameters, working gas, and operational conditions. However, surface interactions are complex and may result from a combination of different mechanisms.

In polymer surface modification, various techniques are commonly used including wet chemical methods, radio frequency (RF) vacuum plasmas, ion beam irradiation, and corona and flame treatments. In wet chemical processing chemicals activate the fabric surface by pure chemical interactions, however large amounts of toxic solvents are required. RF vacuum plasma and ion beam techniques are conducted under vacuum, leading to high cost and limiting treatments to batch processing. Corona and flame treatments are non-uniform and have limited applications. Atmospheric pressure plasma systems, including microwave-coupled, and uniform glow discharge, provide an advantage over vacuum plasmas by providing continuous surface modifications processing at lower cost.

Referring to FIG. 1, an example of a prior art atmospheric plasma-aided technique is shown in which plasma is used to pre-activate the fabric surface, then chemicals are added via a linking agent to arrive at a final product. In previous techniques, a fresh fabric sample 12, such as nonwoven polypropylene (PP), was exposed to atmospheric oxygenated helium plasma 14 to enhance the PP fabric sample 12 prior to grafting and to form a plasma-activated sample 16. The plasma-activated sample 16 was then soaked in a linking agent 18 such as glycidyl methacrylate (GMA) at elevated temperatures of 60-70 degrees Celsius for 40-60 minutes to produce PP/GMA grafts. The grafted PP/GMA epoxide group was reacted with an active antimicrobial agent 22 such as β-cyclodextrin (β-CD) or monochloro trizynyl β-cyclodextrins (MCT-CD) or quaternary ammonium chitosan derivative (HTCC) (a process typically performed at 80 degrees Celsius for 24 hours) to arrive at the final product 24. This prior art process is time consuming (i.e., can only be performed in batch processes), requires elevated temperatures, and requires volumes of chemicals similar to traditional wet chemistry processes.

Therefore, there remains a long-felt need for a method of producing textile fabrics exhibiting antimicrobial characteristics wherein the activation of the fabric surface and inclusion of antimicrobial agents are compiled in a single process without the need for extensive soaking or elevated temperatures.

### SUMMARY

In some embodiments, the presently disclosed subject matter provides a method of producing a textile fabric exhibiting antimicrobial characteristics wherein the method comprises the steps of providing a textile fabric having a fabric surface and providing an antimicrobial agent for inclusion on the fabric surface. The method further comprises exposing the textile fabric to atmospheric pressure plasma wherein the fabric surface is activated and grafting the antimicrobial agent onto the fabric surface during activation of the fabric surface wherein the antimicrobial agent is copolymerized to form a permanent inclusion on the fabric surface. The method can occur within a continuous treatment process or a batch treatment process. Fabrics exhibiting antimicrobial characteristics as produced through the methods disclosed herein are also provided.

The presently disclosed method can include providing a textile fabric selected from the group consisting of woven fabrics, nonwoven fabrics, and knitted fabrics or providing a textile fabric comprising yarns containing fibers selected from the group consisting of natural fibers, synthetic fibers, inorganic fibers, and any blends thereof.

The presently disclosed method can include applying an antimicrobial agent to a fabric surface with an aerosol solution wherein the aerosol solution is applied immediately prior to, during, or immediately after exposing the textile fabric to plasma. The presently disclosed method can further include exposing the textile fabric to plasma selected from the group consisting of helium (He), oxygenated-helium (He/O₂), and helium/CF₄ (He/CF₄) plasmas wherein the plasma provides a gas temperature in the range of 40-70 degrees Celsius.

Thus, it is an object of the presently disclosed subject matter to provide a method of producing a textile fabric exhibiting antimicrobial characteristics.

It is another object of the presently disclosed subject matter to provide a method of producing a textile fabric exhibiting antimicrobial characteristics wherein the activation of the fabric surface and inclusion of antimicrobial agents are compiled in a single process.

Some of the objects of the presently disclosed subject matter having been stated hereinabove, and which are addressed in whole or in part by the presently disclosed subject matter, other objects will become evident as the description proceeds when taken in connection with the accompanying drawings as best described hereinbelow.

### BRIEF DESCRIPTION OF THE DRAWINGS

FIG. 1 is an illustration of a prior art process of antimicrobial textile finishing;

FIG. 2 is a perspective view of a representative system utilizing a continuous flow process according to the presently disclosed subject matter;

FIG. 3 is an illustration of an exemplary electrical circuit of the system illustrated in FIG. 2;

FIG. 4 is an illustration of an exemplary gas manifold of the system illustrated in FIG. 2;

FIG. 5 is a perspective view of a representative system utilizing a batch flow process according to the presently disclosed subject matter;

FIG. 6 is a plan view of a batch treatment cell and gas manifold of the system illustrated in FIG. 5;

FIG. 7 shows Part A experimental plasma exposure sample routes;

FIG. 8 shows Part A experimental % add-on before and after washing to determine the effectiveness of grafting via spraying and plasma activation;

FIG. 9 shows Part B experimental plasma exposure sample routes;

FIG. 10 shows Part B experimental % add-on before and after washing to determine the effectiveness of grafting via spraying and plasma activation;

FIG. 11 shows Fourier Transform Infrared Spectroscopy (FTIR) of sample T compared to control sample to show evidence of grafting;

FIG. 12 shows Fourier Transform Infrared Spectroscopy (FTIR) of sample V compared to control sample to show evidence of grafting;

FIG. 13 shows Fourier Transform Infrared Spectroscopy (FTIR) of sample 3 compared to control sample to show evidence of grafting;

FIG. 14 shows Fourier Transform Infrared Spectroscopy (FTIR) of sample F compared to control sample to show evidence of grafting; and

FIG. 15 shows Fourier Transform Infrared Spectroscopy (FTIR) of sample F minus FTIR of control sample to show evidence of grafting.

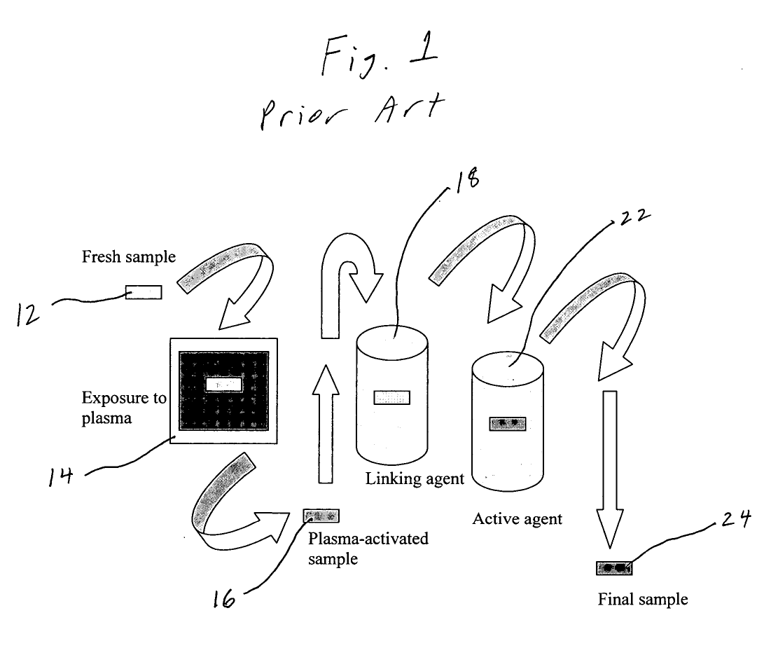

### DETAILED DESCRIPTION

The presently disclosed subject matter is related to atmospheric plasma grafting and surface functionalization of textile materials to provide multi-functional surface finishes, particularly antimicrobial properties. The disclosure herein is specifically related to a continuous treatment aspect, such as which can be adopted for on-line treatment for finishes in a textile mill, or a batch treatment aspect for treatment of fabrics inside a treatment cell, such as for preparation of specific items for special purposes (already fabricated small size products, etc.). The method of the presently disclosed subject matter provides permanent inclusion of antimicrobial agents on the fabric surface of textile materials via graft copolymerization using atmospheric plasma techniques. In these methods, the atmospheric plasma exposed to a fabric surface activates the surface for inclusion of antimicrobial agents via direct linking of the agent into the fibers.

The presently disclosed subject matter provides a technique in which plasma activation and inclusion of agents are compiled in one process, in which the surface activation takes place due to exposure to plasma and the inclusion of the agents is simultaneously grafted into the activated fabrics. The residence time for activation is the same resident time in the plasma, and the immediate inclusion of chemical agents takes place without a linking agent. The temperature of the plasma gas automatically provides the elevated temperature needed for chemical reactions. Inclusion of the agents can be via sprayers, which inject the chemical agents into the plasma stream. Full control can be provided in this technique, including spraying followed by plasma treatment, plasma treatment followed by spraying, spraying followed by plasma treatment followed by spraying, plasma treatment with in-situ spraying, or compiled plasma treatment and spraying. All processes can be conducted in-situ and in real time and do not require wet chemistry or soaking.

In particular, the methods of the presently disclosed subject matter can be applied to a variety of textile fabrics provided to produce fabrics exhibiting antimicrobial characteristics. Fabrics to be treated may comprise, for example, woven fabrics, nonwoven fabrics, and knitted fabrics and the fabrics may comprise yarns containing fibers consisting of natural fibers, synthetic fibers, inorganic fibers, and any blends thereof. The antimicrobial agents provided to be applied on the fabric surface by the methods of the presently disclosed subject matter can include, for example, β-cyclodextrin (β-CD) or monochloro trizynyl β-cyclodextrins (MCT-CD) or quaternary ammonium chitosan derivative (HTCC). Additionally, the plasma envisioned by the presently disclosed subject matter can include any atmospheric pressure plasma, such as, for example, helium (He), oxygenated-helium (He/O₂), and helium/CF₄ (He/CF₄) plasma, each of which can provide a gas temperature in the process in the range of 50-60 degrees Celsius. However, it is believed that a gas temperature between about 40 degrees Celsius and 70 degrees Celsius will have sufficient efficiency in the process disclosed herein.

The antimicrobial agents applied to the fabric surface in accordance with the present subject matter can preferably be applied to the fabric surface with an aerosol solution. This aerosol solution can be applied immediately prior to, during, or immediately after the exposure of the textile fabric to the plasma gas. In order to enhance the ability of the antimicrobial agent to graft to the fabric surface, it is envisioned that a catalyst may be applied to the fabric surface. This catalyst can be applied immediately prior to or during exposing of the textile fabric to the plasma and excites the fabric surface to enhance the copolymerization of the antimicrobial agent into the surface.

In order to provide the resulting fabric with additional surface finish qualities (e.g., water repellency, etc.), the presently disclosed subject matter further envisions the application of additional surface enhancing agents to the fabric surface. Depending on the additional surface finish qualities desired, these surface enhancing agents may include, for example, p-hydroxy benzoic acid, AgNO₃—ethanolamine mixture, iodine, and Ag/Ti compounds. In accordance with the disclosure herein, the additional surface enhancing agents preferably can be applied to the fabric surface during or immediately after exposing of the textile fabric to the atmospheric plasma gases.

### I. EXPERIMENTAL SYSTEM

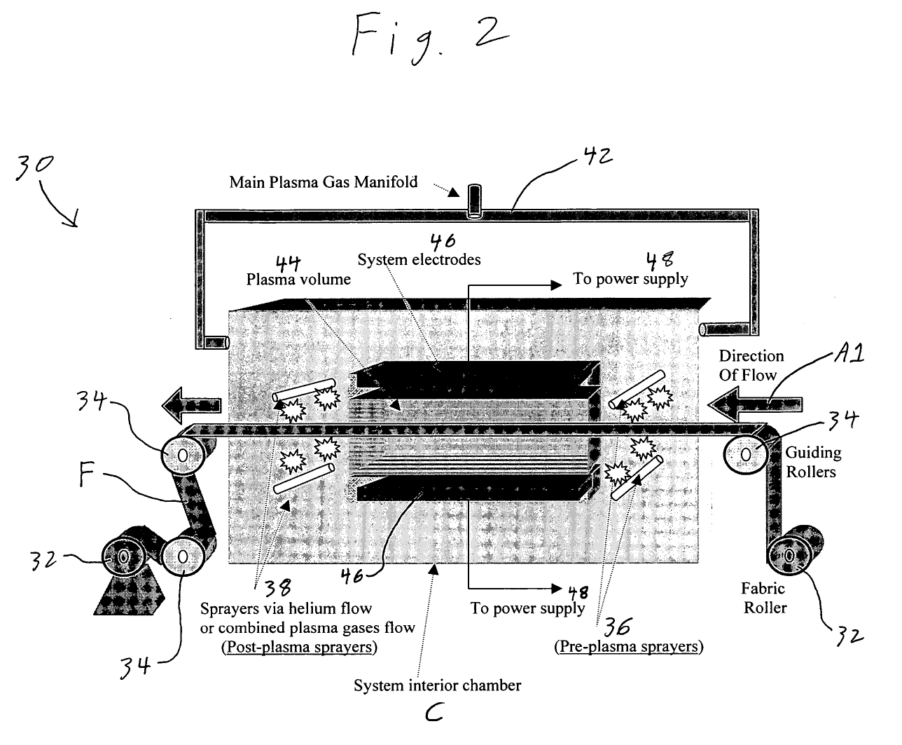

Referring to FIG. 2, a representative system 30 utilizing a continuous flow process of the presently disclosed subject matter is illustrated. As shown in FIG. 2, a fabric F is directed into and out of an interior chamber C of system 30 by fabric rollers 32 and guiding rollers 34, such as in the direction of arrow A1. At the dispatch, prior to final winding, heating elements (not shown) can be provided to enhance drying of fabric F. System 30 can include pre-plasma sprayers 36 such as for applying antimicrobial agents by aerosol solution and can further include post-plasma sprayers 38 for applying antimicrobial agents and/or for applying additional surface agents to further enhance the surface treatment or provide additional functions to fabric F. Plasma gas is provided to interior chamber C by way of a main plasma gas manifold 42 from plasma gas tanks (not shown). The plasma gas fills a plasma volume 44 between two system electrodes 46, each electrode connected to a power supply 48. Fabric F is directed through plasma volume 44 wherein the surface of fabric F is activated for linking of active antimicrobial agents into the fabric molecular chain.

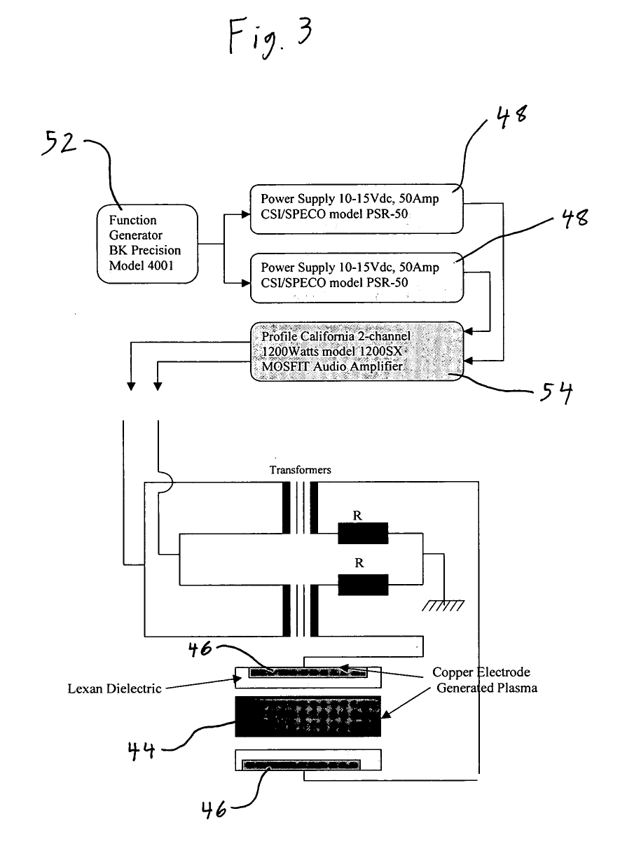

An exemplary electrical circuit for use with system 30 is shown in FIG. 3. A function generator 52 is tuned to the desired operating frequency (between 4 to 12 kHz), and is connected to DC power supplies 48. Thus, the potential from power supplies 48 is oscillating at the frequency of function generator 52. A 2-CH audio amplifier 54 amplifies the output of power supplies 48. The output of amplifier 54 is fed to upper and lower electrodes 46 of system 30 (see FIGS. 2 and 3).

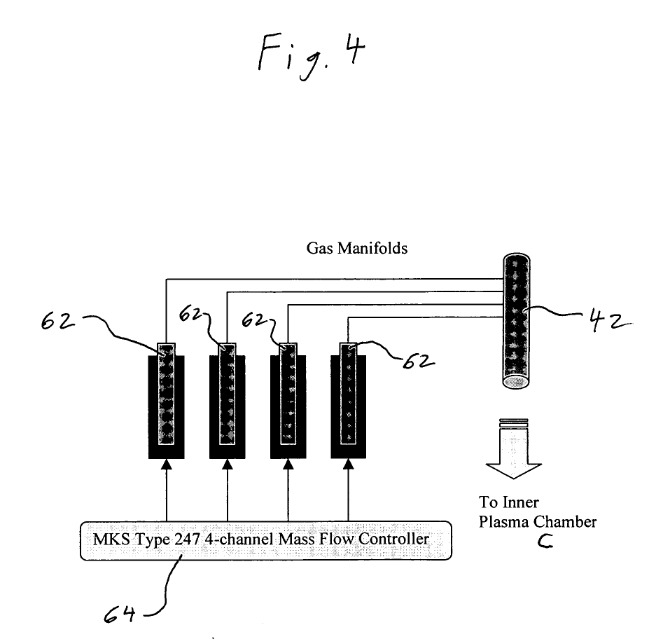

The atmospheric pressure plasma facility exemplified as system 30 can be operated at ambient conditions (760 Torr pressure and ambient temperature). Preferably, it has a capacitively-coupled dielectric barrier discharge (DBD) operated by a 4.8 kW audio frequency power supply at 4-10 kHz. Two transformers 180° out of phase are coupled to the power supply to provide the high voltage to electrodes 46. The device preferably has an active exposure area of approximately 60×60 cm between two copper electrodes 46 with a fixed 5 cm gap separation; however, the system has the capability to operate at up to 8 cm gap separation. Helium gas is preferably used as the seed gas to initiate the discharge and is injected between electrodes 46 into test cell interior chamber C at a constant flow rate of approximately 10 L/m via a mass flow controller 64 (see FIG. 4). Other gases such as oxygen, argon, nitrogen, hydrogen, CF₄, C₃F₆, forming gas (90% N₂+10% H₂), CH₄, CO₂, could be added at a specific flow rate into chamber C for other desired treatments. The dielectric-barrier discharge preferably is a non-equilibrium discharge generating low-temperature (1-2 eV), low electron number density (10¹⁴-10¹⁶/m³) pseudo-glow discharge plasma, which is typical for dielectric-barrier discharges at atmospheric pressure. The discharge generated electrons, ions, excited atoms and molecules, as well as UV radiation.

The desired plasma gases are supplied to inner chamber C via a gas manifold system, an example of which is illustrated in FIG. 4. Each gas cylinder (not shown) is connected to a mass flow manifold unit 62, and a total of 4 units are experimentally used at the same time. A 4-channel mass flow controller and readout unit 64, as shown in FIG. 4, controls mass flow manifold units 62. Mass flow units 62 are connected to gas manifold 42, which in turn supplies gas to inner plasma chamber C.

Referring to FIGS. 5 and 6, and as described hereinabove, the option of batch treatment for pre-fabricated small items allows for application of active agents and plasma treatment in any desired sequence, or simultaneous spraying and plasma treatment. Batch system 70 can comprise features similar to continuous system 30, such as electrodes 46, power supply 48, interior chamber C, and plasma volume 44, and can further include a batch treatment cell 72 and sample supporting grid 74. Batch treatment cell 72 has a unique design that provides uniform plasma gas flow and the injection of the active agents into the cell, as shown in FIG. 5. FIG. 6 further illustrates the batch treatment and gas manifold system, including sample supporting grid 74, frame 76 (comprised of PLEXIGLAS™, LEXAN™, or GAROLITE™) for supporting grid 74, main feed line M, piping P, gas valves V, plasma gas tanks G, and monomer sprayer 78.

As discussed previously, an important feature of the batch or continuous treatment processes of the presently disclosed subject matter is that there is no need for soaking of fabrics in an active solution for long time periods at high temperatures. The plasma gas provides a hot environment between the two electrodes, in the range between 40 degrees Celsius and 60 degrees Celsius, and thus the necessary temperature for active agents to link to the fabric molecular chain is automatically provided.

### II. REPRESENTATIVE EXPERIMENTS

Spraying experiments were conducted to test the methods of the presently disclosed subject matter on cellulose fibers (in paper form) in order to assess the effectiveness of spraying and plasma activation as a test bed for the new methods. The experiments used batch processes to verify atmospheric pressure plasma treatment and grafting effectiveness.

### II.A. IP PAPER EXPERIMENT RESULTS—PART A

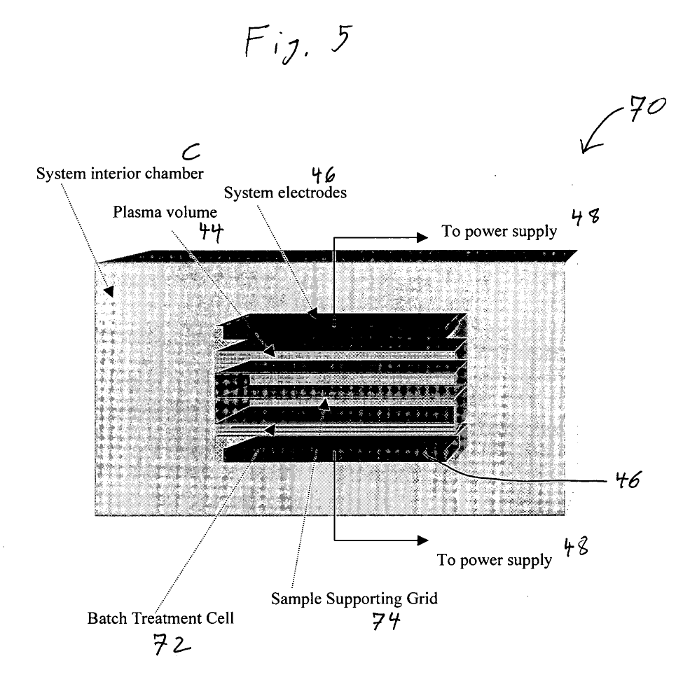

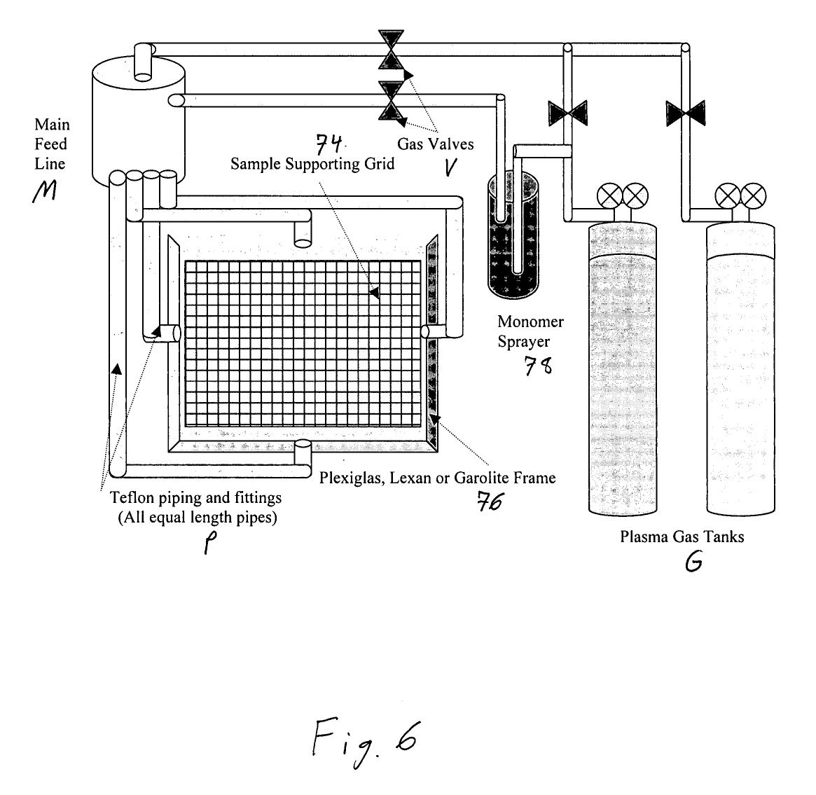

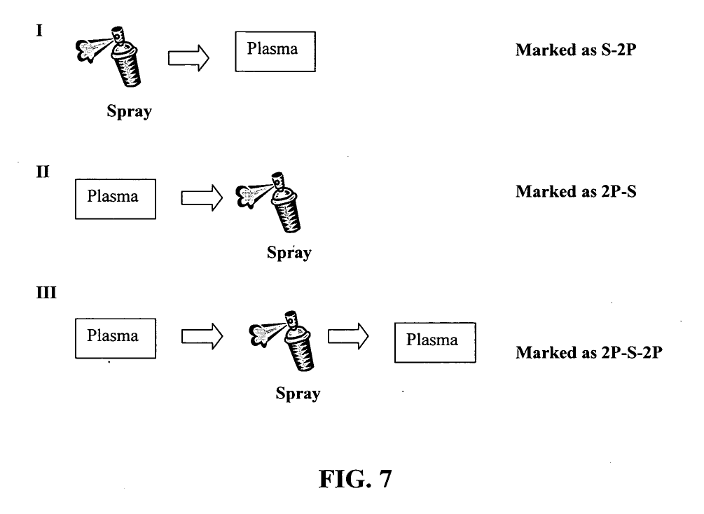

Paper samples (from International Paper) were cut into 3-inch squares and conditioned for over 24 hours at a constant temperature (21 degrees Celsius) and pressure (760 Torr). Each sample was marked in the corner with a sample name (A-Z or 1-6) and weighed. These samples were then treated for two minutes with 1% oxygenated helium plasma and an aerosol spray of one of the following solutions: glycidyl methacrylate (50% GMA, 50% water), chitosan (5g quaternized chitosan “quaternary ammonium chitosan HTCC” in 100 mL water), or β-cyclodextrin (3g β-CD, 1 g NaCl, 1g NaOH, 100 mL water). The method of solution application in conjunction with plasma exposure followed one of the routes I-III as shown in FIG. 7.

After plasma treatment and spray application of the solution, the samples were returned to a standard temperature and pressure (STP) room for 24 hours. They were then weighed and washed (to remove un-grafted solution) by applying water and blotting with a paper towel. After washing, they were returned to the STP room for another 24 plus hours. Then they were reweighed and the % add-on of the grafted solution was calculated.

Sample results, before washing, were as follows:
Grafting Procedure Code:
   S=Spray with chemical
   2P=2 minutes 1% Oxygenated Helium Plasma

-=indicates a consecutive execution

| | | | | Weight | | |
|---|---|---|---|---|---|---|
| | | | | at | | |
| | | | Initial | STP | | |
| Sam- | Chemical | Grafting | Weight | before | | Weight |
| ple | Grafted | Procedure | at STP | washing | % Add-on | Gain (g) |
| B | Chitosan | 2P-S | 4.511 | 4.763 | 5.58634449 | 0.252 |
| C | Chitosan | S-2P | 4.312 | 4.523 | 4.89332096 | 0.211 |
| D | Chitosan | 2P-S-2P | 4.327 | 4.542 | 4.96880055 | 0.215 |
| K | β-CD | S-2P | 4.552 | 4.765 | 4.67926186 | 0.213 |
| H | β-CD | 2P-S-2P | 4.756 | 5.028 | 5.71909167 | 0.272 |

Sample results, after washing, were as follows:
Grafting Procedure Code:
   S=Spray with chemical
   2P=2 minutes 1% Oxygenated Helium Plasma

-=indicates a consecutive execution

| | | | Initial | | | |
|---|---|---|---|---|---|---|
| | | | Weight | Final Weight | % | |
| | Chemical | Grafting | at | at STP after | Add- | Weight |
| Sample | Grafted | Procedure | STP | one washing | on | Gain (g) |
| B | Chitosan | 2P-S | 4.511 | 4.768 | 5.70 | 2.57 |
| C | Chitosan | S-2P | 4.312 | 4.542 | 5.33 | 0.23 |
| D | Chitosan | 2P-S-2P | 4.327 | 4.637 | 7.16 | 0.31 |
| K | β-CD | S-2P | 4.552 | 4.775 | 4.99 | 0.223 |
| H | β-CD | 2P-S-2P | 4.756 | 4.981 | 4.73 | 0.0225 |

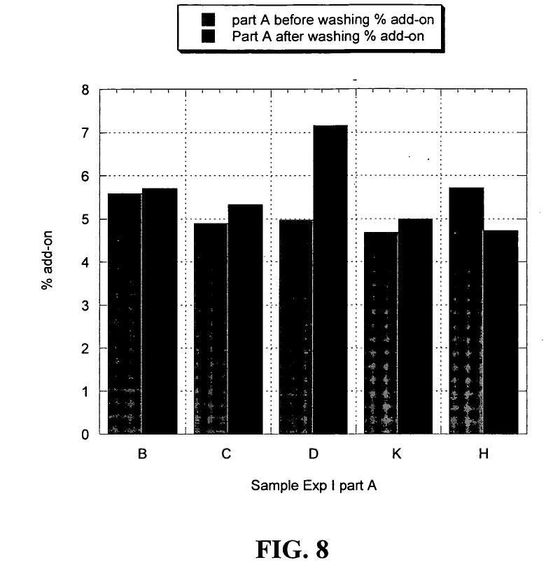

The % add-on was then plotted for the before and after washing data to determine the effectiveness of grafting via spraying and plasma activation, as shown in FIG. 8. The % add-on represents the graft yield of the added antimicrobial agent (Chitosan or β-cyclodextrin).

On average and as shown in FIG. 8, the % add-on is about 5% (±) amongst samples B, C, D, K and H (although a higher graft yield at more than 7% add-on after washing was noted in sample D). The results indicate that grafting remains on the samples and that the washing only removed excess layers. It appears from these results that the differences between the various application methods are minimal, and thus pre-plasma spraying or post-plasma spraying or intermediary spraying between plasma treatments yields similar results. The importance of these different sequences is that all combinations of spraying and plasma exposure are, on average, yielding approximately the same graft yield. Thus, the method of the presently disclosed subject matter is successful in grafting antimicrobial agents on cellulose fibers.

### II.B. IP PAPER EXPERIMENTS RESULTS-PART B

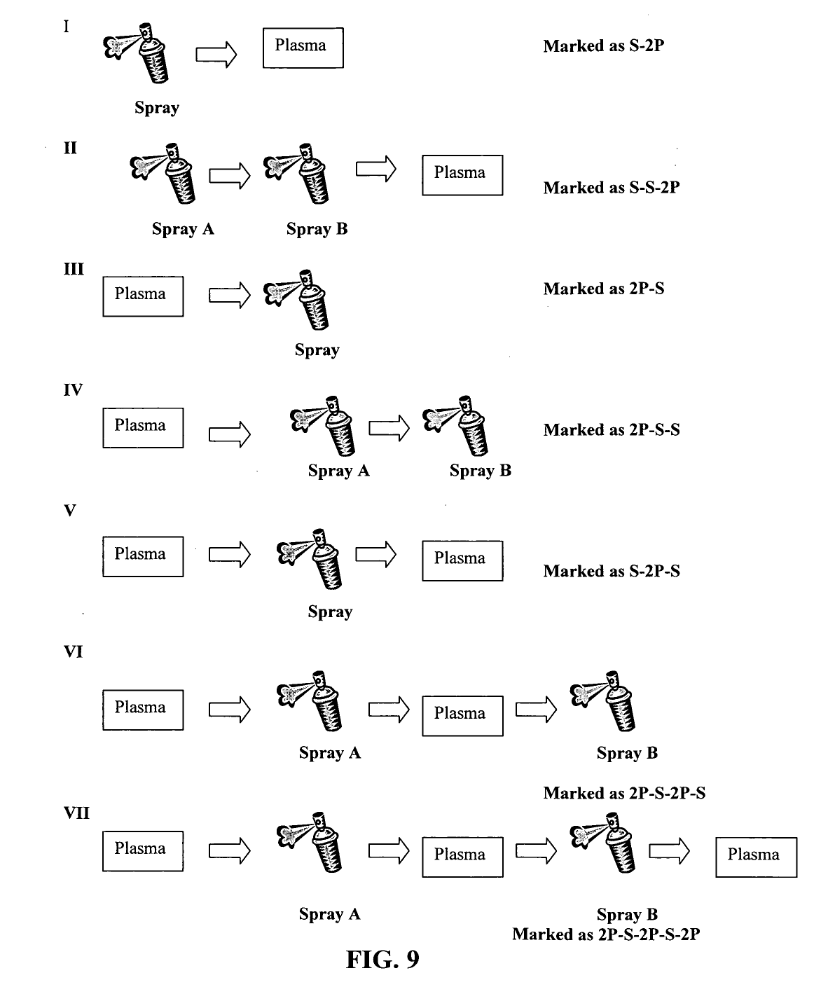

Following the Part A experiment discussed above, the samples grafted with GMA were then retreated with plasma to graft β-CD, Chitosan, or both onto the GMA. Methods of spray and plasma variation were used to apply the solution according to routes I-VII as shown in FIG. 9. The samples continued to be weighed after conditioning and were also washed and reweighed as described in the Part A experiment above. The % add-on of the grafted solutions was then calculated.

Sample results, before washing, were as follows:
Grafting Procedure Code:
   S=Spray with chemical
   2P=2 minutes 1% Oxygenated Helium Plasma
   -=indicates a consecutive execution
   (Ch)=indicates chitosan

(β)=indicates β-CD

| | | | % | Weight at | | | |
|---|---|---|---|---|---|---|---|
| | | | Grafting | STP after | Weight | | |
| | | | of GMA | GMA | at STP | | |
| | Prior | | after | grafting | after | % | |
| | Treatment | Grafting | one | and 1 | second | Add- | Weight Gain |
| Sample | Chemical | Procedure | washing | washing | grafting | on | (g) |
| F | GMA | 2P-S(Ch) | 2.65 | 4.493 | 4.801 | 6.86 | 0.308 |
| U | GMA | 2P-S(β- | 2.85 | 4.552 | 4.975 | 9.29 | 0.423 |
| | | CD) | | | | | |
| V | GMA | S(β)-2P | 2.48 | 4.592 | 4.956 | 7.93 | 0.364 |
| X | GMA | S(Ch)- | 3.59 | 4.644 | 5.070 | 9.17 | 0.426 |
| | | S(β)-2P | | | | | |
| G | GMA | S(Ch)-2P | 3.04 | 4.637 | 5.022 | 8.30 | 0.385 |
| L | GMA | 2P- | 2.44 | 4.579 | 4.937 | 7.82 | 0.358 |
| | | S(Ch)-2P | | | | | |
| P | GMA | 2P-S(β)- | 3.7 | 4.741 | 5.178 | 9.22 | 0.437 |
| | | 2P | | | | | |
| T | GMA | 2P- | 2.99 | 4.529 | 5.114 | 12.92 | 0.585 |
| | | S(Ch)- | | | | | |
| | | 2P-S(β)- | | | | | |
| | | 2P | | | | | |
| 2 | GMA | 2P- | 6.31 | 4.7227 | 5.042 | 6.76 | 0.3193 |
| | | S(Ch)- | | | | | |
| | | 2P(β) | | | | | |
| 3 | GMA | 2P-S(β)- | 4.88 | 4.6763 | 5.445 | 16.44 | 0.7687 |
| | | 2P-S(Ch) | | | | | |

Sample results, after washing, were as follows:

| | | | | Weight | | Weight | | |
|---|---|---|---|---|---|---|---|---|
| | | | % | at STP | | at STP | | |
| | | | Grafting | after | Weight | after | | |
| | | | of GMA | GMA | at STP | second | | |
| | Prior | | after | grafting | after | grafting | | |
| | Treatment | Grafting | one | and 1 | second | AND | % add- | Weight |
| Sample | Chemical | Procedure | washing | washing | grafting | washing | on | Gain (g) |
| F | GMA | 2P-S(Ch) | 2.65 | 4.493 | 4.801 | 4.877 | 8.55 | 0.384 |
| U | GMA | 2P-S(β-CD) | 2.85 | 4.552 | 4.975 | 4.833 | 6.17 | 0.281 |
| V | GMA | S(β)-2P | 2.48 | 4.592 | 4.956 | 5.060 | 10.19 | 0.468 |
| X | GMA | S(Ch)-S(β-2P) | 3.59 | 4.644 | 5.070 | 4.909 | 5.71 | 0.265 |
| G | GMA | S(Ch)-2P | 3.04 | 4.637 | 5.022 | 4.840 | 4.38 | 0.203 |
| L | GMA | 2P-S(Ch)-2P | 2.44 | 4.579 | 4.937 | 4.938 | 7.84 | 0.359 |
| P | GMA | 2P-S(β)-2P | 3.7 | 4.741 | 5.178 | 4.931 | 4.01 | 0.19 |
| T | GMA | 2P-S(Ch)-2P- | 2.99 | 4.529 | 5.114 | 4.866 | 7.44 | 0.337 |
| | | S(β)-2P | | | | | | |
| 2 | GMA | 2P-S(Ch)- | 6.31 | 4.7227 | 5.042 | 4.947 | 4.75 | 0.2243 |
| | | 2P(β) | | | | | | |
| 3 | GMA | 2P-S(β)-2P- | 4.88 | 4.6763 | 5.445 | 5.069 | 8.40 | 0.3927 |
| | | S(Ch) | | | | | | |

The results indicate that the add-on for chitosan is greater than it was for GMA. This high graft yield is unlikely unless the chitosan has been directly bonded to the fabric (in places where the GMA has not been bonded).

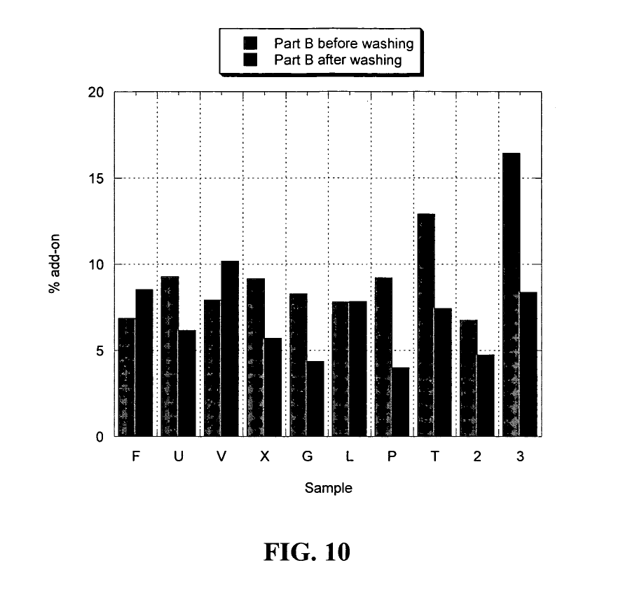

The % add-on was then plotted for the before and after washing data to determine the effectiveness of grafting via spraying and plasma activation, as shown in FIG. 10. The % add-on represents the graft yield of the added antimicrobial agent (Chitosan or β-cyclodextrin or both).

As shown in FIG. 10, the % add-on differs from the first Part A experiment, probably due to the higher bonding of the linking agent (GMA). The results show that grafting remains on the samples and that the washing only removed excess layers as seen from all samples except samples F and V, where the after washing shows a higher graft yield. Sample L has no change in the graft yield for before and after washing, indicating that all grafted chitosan is well bonded to the fibers. The lowest graft yield, after washing, is for samples G and P (about 4%), and the highest graft yield after washing is for samples F, V, L and 3 (about 6-7%). In this experiment, it appeared that the difference between the various application methods affects the graft yield. Best is seen from sample V in which the process was S(β-CD)-2P with a 10% graft yield. The importance of these different sequences is that all combinations of spraying and plasmas exposure in the experiment indicate a good graft yield sufficient for antimicrobial effectiveness. Thus, the method of the presently disclosed subject matter is successful in grafting antimicrobial agents on cellulose fibers.

As additionally shown in FIG. 10, samples X (% add-on after washing of 5.71%), T (% add-on after washing of 7.44%), 2 (% add-on after washing of 4.75%), and 3 (% add-on after washing of 8.40%) are more interesting as they were grafted with both antimicrobial agents (β-cyclodextrin and chitosan), which means that their antimicrobial effectiveness will be attributed to the double grafting of two agents. Given the fact that cyclodextrin has cavities, it is possible that part of the grafted chitosan resided inside of the CD cavities.

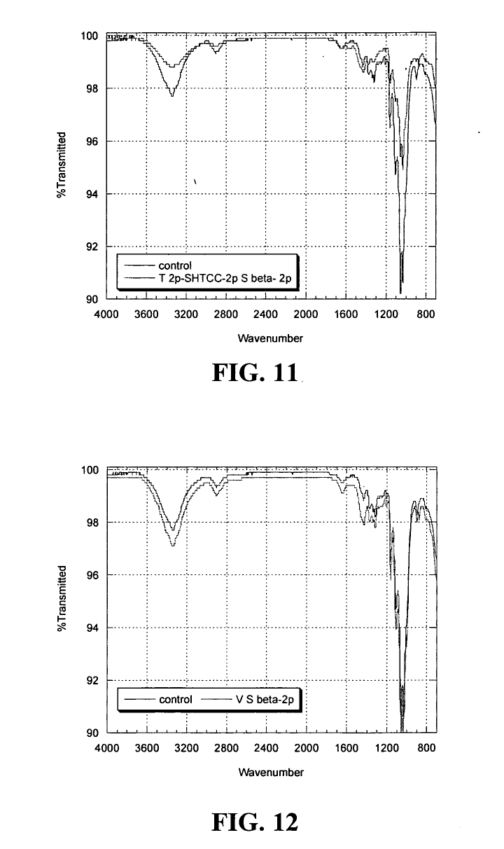

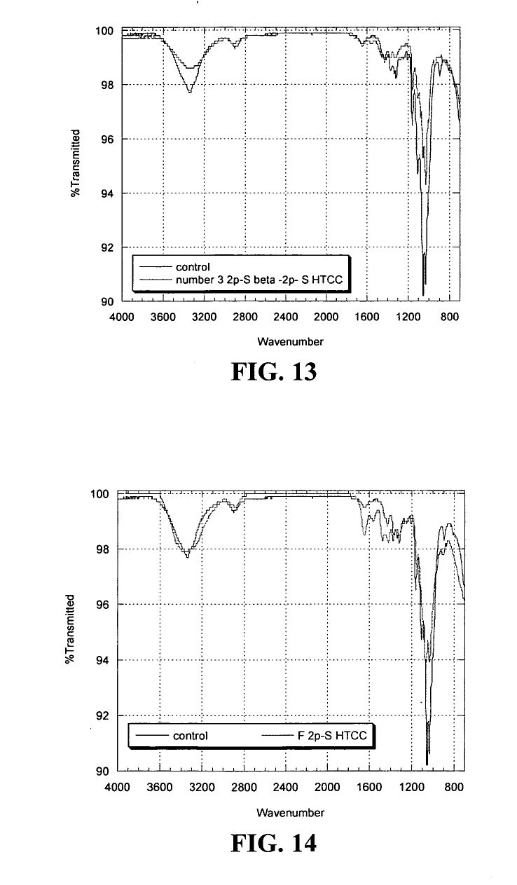

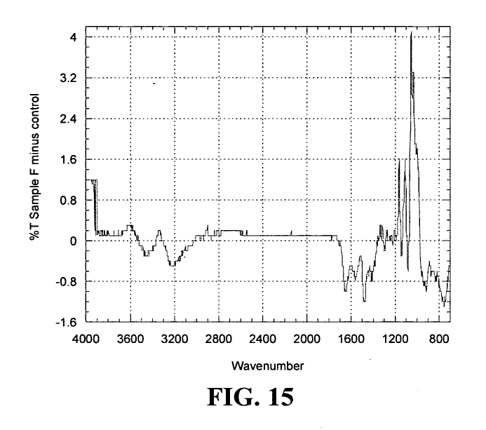

FIGS. 11-15 illustrate a comparison of the Fourier Transform Infrared Spectroscopy (FTIR) of treated samples for the showing of evidence of grafting. FIG. 11 illustrates the FTIR of sample T compared to a control sample wherein the grafting procedure was 2P—S(Ch)-2P—S(β)-2P. FIG. 12 illustrates the FTIR of sample V compared to a control sample wherein the grafting procedure was S(β)-2P. FIG. 13 illustrates the FTIR of sample 3 compared to a control sample wherein the grafting procedure was 2P—S(β)-2P—S(Ch). The absorbance band at 3348.7 cm⁻¹ is indicative of the —OH group of the cyclodextrin. FIG. 14 illustrates the FTIR of sample F compared to a control sample wherein the grafting procedure was 2P—S(Ch). Finally, FIG. 15 illustrates the FTIR of sample F minus FTIR of the control sample wherein the grafting procedure was 2P—S(Ch). The quaternary ammonium chitosan characteristic bands are at 1641 and 1480 cm⁻¹.

### III. REFERENCES

The references listed below are incorporated herein by reference to the extent that they supplement, explain, provide a background for or teach methodology, techniques and/or processes employed herein. All cited publications referred to in this application are herein expressly incorporated by reference.

“Modifying Nylon and Polypropylene Fabrics with Atmospheric Pressure Plasmas”, M. G. McCord, Y. J. Hwang, P. J. Hauser, Y. Qui, J. J. Cuomo, O. Hankins, M. A. Bourham and L. K. Canup, Textile Research Journal, Vol. 72, No. 6, pp. 491-498, June 2002.

“Surface Analysis of Cotton Fabrics Fluorinated in Radio-Frequency Plasma”, M. G. McCord, Y. J. Hwang, Y. Qiu, K. L. Hughes and M. A. Bourham, J. Applied Polymer Science, Vol. 88, Issue 8, pp. 2038-2047, May 2003.

“Surface Modification of Organic Polymer Films Treated in Atmospheric Plasmas”, Yoon J. Hwang, Suzanne Matthews, Marian McCord and Mohamed Bourham, J. Electrochemical Soc., Vol. 151, No. 7, pp. C495-C4501, June 2004.

“Investigation into Etching Mechanism of Polyethylene Terephthalate (PET) Films Treated with Helium and Oxygenated Helium Atmospheric Plasmas”, Suzanne R. Matthews, Yoon J. Hwang, Marian G. McCord and Mohamed A. Bourham, J. Applied Polymer Science, Vol. 94 Issue 6, pp. 2383-2389, October 2004.

“Plasma and Antimicrobial Treatment of Nonwoven Fabrics for Surgical Gowns”, Rajpreet K. Virk and Gita N. Ramaswamy (Kansas State University), and Mohamed Bourham and Brian L. Bures (N.C. State University), Textile Research Journal, Vol. 74(12), pp. 1073-1079, December 2004.

“Poly (vinyle alcohol) Desizing Mechanism Via Atmospheric Pressure Plasma Exposure”, Suzanne R. Matthews, Marian G. McCord and Mohamed A. Bourham, Plasma Processes & Polymers, Vol. 2, pp. 702-708, November 2005.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method of producing a textile fabric exhibiting antimicrobial characteristics, the method comprising the steps of:
a) providing a textile fabric having a fabric surface;
b) providing an antimicrobial agent for inclusion on the fabric surface;
c) exposing the textile fabric to atmospheric pressure plasma wherein the fabric surface is activated; and
d) grafting the antimicrobial agent onto the fabric surface during activation of the fabric surface wherein the antimicrobial agent is copolymerized to form a permanent inclusion on the fabric surface.

2. The method according to claim 1 wherein the step of providing a textile fabric comprises providing a textile fabric selected from the group consisting of woven fabrics, nonwoven fabrics, and knitted fabrics.

3. The method according to claim 1 wherein the step of providing a textile fabric comprises providing a textile fabric comprising yarns containing fibers selected from the group consisting of natural fibers, synthetic fibers, inorganic fibers, and any blends thereof.

4. The method according to claim 1 wherein the step of providing an antimicrobial agent comprises providing an antimicrobial agent selected from the group consisting of β-cyclodextrin (β-CD), monochloro trizynyl β-cyclodextrins (MCT-CD), and quaternary ammonium chitosan derivative (HTCC).

5. The method according to claim 1 wherein the step of providing an antimicrobial agent further comprises applying the antimicrobial agent to the fabric surface with an aerosol solution.

6. The method according to claim 5 wherein the step of applying the antimicrobial agent with an aerosol solution comprises applying the aerosol solution immediately prior to exposing the textile fabric to plasma.

7. The method according to claim 6 further comprising the step of applying a catalyst to the fabric surface.

8. The method according to claim 7 wherein the step of applying a catalyst to the fabric surface comprises applying the catalyst immediately prior to exposing the textile fabric to plasma.

9. The method according to claim 7 wherein the step of applying a catalyst to the fabric surface comprises applying the catalyst during exposing the textile fabric to plasma.

10. The method according to claim 5 wherein the step of applying the antimicrobial agent with an aerosol solution comprises applying the aerosol solution during exposing the textile fabric to plasma.

11. The method according to claim 5 wherein the step of applying the antimicrobial agent with an aerosol solution comprises applying the aerosol solution immediately after exposing the textile fabric to plasma.

12. The method according to claim 1 wherein the step of exposing the textile fabric to atmospheric pressure plasma comprises exposing the textile fabric to plasma selected from the group consisting of helium (He), oxygenated-helium (He/O₂), and helium/CF₄ (He/CF₄) plasmas.

13. The method according to claim 1 wherein the step of exposing the textile fabric to atmospheric pressure plasma comprises exposing the textile fabric to plasma providing a gas temperature in the range of 40-70 degrees Celsius.

14. The method according to claim 1 wherein the step of grafting the antimicrobial agent onto the fabric surface is conducted without the use of a linking agent.

15. The method according to claim 1 wherein the method steps occur within a continuous treatment process.

16. The method according to claim 1 wherein the method steps occur within a batch treatment process.

17. The method according to claim 1 further comprising the step of applying an additional surface enhancing agent to the fabric surface.

18. The method according to claim 17 wherein the step of applying an additional surface enhancing agent to the fabric surface comprises applying a surface enhancing agent during exposing the textile fabric to plasma.

19. The method according to claim 17 wherein the step of applying an additional surface enhancing agent to the fabric surface comprises applying a surface enhancing agent immediately after exposing the textile fabric to plasma.

20. The method according to claim 17 wherein the step of applying an additional surface enhancing agent to the fabric surface comprises applying a surface enhancing agent selected from the group consisting of p-hydroxy benzoic acid, AgNO₃—ethanolamine mixture, iodine, and Ag/Ti compound.

21. A textile fabric exhibiting antimicrobial characteristics, wherein the fabric is treated through the method according to claim 1.

22. A method of producing a textile fabric exhibiting antimicrobial characteristics, the method comprising the steps of:
a) providing a textile fabric having a fabric surface;
b) providing an antimicrobial agent for inclusion on the fabric surface;
c) applying the antimicrobial agent to the fabric surface with an aerosol solution;
d) exposing the textile fabric to atmospheric pressure plasma wherein the fabric surface is activated;
e) grafting the antimicrobial agent onto the fabric surface during activation of the fabric surface wherein the antimicrobial agent is copolymerized to form a permanent inclusion on the fabric surface; and
f) wherein the method steps occur within a continuous treatment process.

23. The method according to claim 22 wherein the step of providing a textile fabric comprises providing a textile fabric selected from the group consisting of woven fabrics, nonwoven fabrics, and knitted fabrics.

24. The method according to claim 22 wherein the step of providing a textile fabric comprises providing a textile fabric comprising yarns containing fibers selected from the group consisting of natural fibers, synthetic fibers, inorganic fibers, and any blends thereof.

25. The method according to claim 22 wherein the step of providing an antimicrobial agent comprises providing an antimicrobial agent selected from the group consisting of β-cyclodextrin (β-CD), monochloro trizynyl β-cyclodextrins (MCT-CD), and quaternary ammonium chitosan derivative (HTCC).

26. The method according to claim 22 wherein the step of applying the antimicrobial agent with an aerosol solution comprises applying the aerosol solution immediately prior to exposing the textile fabric to plasma.

27. The method according to claim 26 further comprising the step of applying a catalyst to the fabric surface.

28. The method according to claim 27 wherein the step of applying a catalyst to the fabric surface comprises applying the catalyst immediately prior to exposing the textile fabric to plasma.

29. The method according to claim 27 wherein the step of applying a catalyst to the fabric surface comprises applying the catalyst during exposing the textile fabric to plasma.

30. The method according to claim 22 wherein the step of applying the antimicrobial agent with an aerosol solution comprises applying the aerosol solution during exposing the textile fabric to plasma.

31. The method according to claim 22 wherein the step of applying the antimicrobial agent with an aerosol solution comprises applying the aerosol solution immediately after exposing the textile fabric to plasma.

32. The method according to claim 22 wherein the step of exposing the textile fabric to atmospheric pressure plasma comprises exposing the textile fabric to plasma selected from the group consisting of helium (He), oxygenated-helium (He/O₂), and helium/CF₄ (He/CF₄) plasmas.

33. The method according to claim 22 wherein the step of exposing the textile fabric to atmospheric pressure plasma comprises exposing the textile fabric to plasma providing a gas temperature in the range of 40-70 degrees Celsius.

34. The method according to claim 22 wherein the step of grafting the antimicrobial agent onto the fabric surface is conducted without the use of a linking agent.

35. The method according to claim 22 further comprising the step of applying an additional surface enhancing agent to the fabric surface.

36. The method according to claim 35 wherein the step of applying an additional surface enhancing agent to the fabric surface comprises applying a surface enhancing agent during exposing the textile fabric to plasma.

37. The method according to claim 35 wherein the step of applying an additional surface enhancing agent to the fabric surface comprises applying a surface enhancing agent immediately after exposing the textile fabric to plasma.

38. The method according to claim 35 wherein the step of applying an additional surface enhancing agent to the fabric surface comprises applying a surface enhancing agent selected from the group consisting of p-hydroxy benzoic acid, AgNO₃— ethanolamine mixture, iodine, and Ag/Ti compound.

39. A textile fabric exhibiting antimicrobial characteristics, wherein the fabric is treated through the method according to claim 22.

40. A method of producing a textile fabric exhibiting antimicrobial characteristics, the method comprising the steps of:
a) providing a textile fabric having a fabric surface;
b) providing an antimicrobial agent for inclusion on the fabric surface;
c) applying the antimicrobial agent to the fabric surface with an aerosol solution;
d) exposing the textile fabric to atmospheric pressure plasma wherein the fabric surface is activated;
e) grafting the antimicrobial agent onto the fabric surface during activation of the fabric surface wherein the antimicrobial agent is copolymerized to form a permanent inclusion on the fabric surface; and
f) wherein the method steps occur within a batch treatment process.

41. The method according to claim 40 wherein the step of providing a textile fabric comprises providing a textile fabric selected from the group consisting of woven fabrics, nonwoven fabrics, and knitted fabrics.

42. The method according to claim 40 wherein the step of providing a textile fabric comprises providing a textile fabric comprising yarns containing fibers selected from the group consisting of natural fibers, synthetic fibers, inorganic fibers, and any blends thereof.

43. The method according to claim 40 wherein the step of providing an antimicrobial agent comprises providing an antimicrobial agent selected from the group consisting of β-cyclodextrin (β-CD), monochloro trizynyl β-cyclodextrins (MCT-CD), and quaternary ammonium chitosan derivative (HTCC).

44. The method according to claim 40 wherein the step of applying the antimicrobial agent with an aerosol solution comprises applying the aerosol solution immediately prior to exposing the textile fabric to plasma.

45. The method according to claim 44 further comprising the step of applying a catalyst to the fabric surface.

46. The method according to claim 45 wherein the step of applying a catalyst to the fabric surface comprises applying the catalyst immediately prior to exposing the textile fabric to plasma.

47. The method according to claim 45 wherein the step of applying a catalyst to the fabric surface comprises applying the catalyst during exposing the textile fabric to plasma.

48. The method according to claim 40 wherein the step of applying the antimicrobial agent with an aerosol solution comprises applying the aerosol solution during exposing the textile fabric to plasma.

49. The method according to claim 40 wherein the step of applying the antimicrobial agent with an aerosol solution comprises applying the aerosol solution immediately after exposing the textile fabric to plasma.

50. The method according to claim 40 wherein the step of exposing the textile fabric to atmospheric pressure plasma comprises exposing the textile fabric to plasma selected from the group consisting of helium (He), oxygenated-helium (He/O₂), and helium/CF₄ (He/CF₄) plasmas.

51. The method according to claim 40 wherein the step of exposing the textile fabric to atmospheric pressure plasma comprises exposing the textile fabric to plasma providing a gas temperature in the range of 40-70 degrees Celsius.

52. The method according to claim 40 wherein the step of grafting the antimicrobial agent onto the fabric surface is conducted without the use of a linking agent.

53. The method according to claim 40 further comprising the step of applying an additional surface enhancing agent to the fabric surface.

54. The method according to claim 53 wherein the step of applying an additional surface enhancing agent to the fabric surface comprises applying a surface enhancing agent during exposing the textile fabric to plasma.

55. The method according to claim 53 wherein the step of applying an additional surface enhancing agent to the fabric surface comprises applying a surface enhancing agent immediately after exposing the textile fabric to plasma.

56. The method according to claim 53 wherein the step of applying an additional surface enhancing agent to the fabric surface comprises applying a surface enhancing agent selected from the group consisting of p-hydroxy benzoic acid, AgNO₃— ethanolamine mixture, iodine, and Ag/Ti compound.

57. A textile fabric exhibiting antimicrobial characteristics, wherein the fabric is treated through the method according to claim 40.
